(19) United States
(12) Patent Application Publication
(10) Pub. No.: US 2011/0090585 A1
(43) Pub. Date: Apr. 21, 2011

(54) Method and apparatus for the Disassembly and Destruction of a Hard Disk Drive

(76) Inventor: Lawrence Robert Schwarcz, Campbell, CA (US)

(21) Appl. No.: 12/904,772

(22) Filed: Oct. 14, 2010

Related U.S. Application Data
(60) Provisional application No. 61/278,969, filed on Oct. 14, 2009.

(51) Int. Cl. G11B 5/02; B65D 85/00

(52) U.S. Cl. 360/57; 206/223; G9B/5.026

(57) ABSTRACT

A method of destroying data on a data platter comprises performing at least one of degaussing at least a portion of the data platter, removing at least a portion of a recording surface of the data platter, or deforming at least a portion of the data platter, and performing at least a different one of degaussing at least a portion of the data platter, removing at least a portion of a recording surface of the data platter, or deforming at least a portion of the data platter. A kit for destroying data on a data platter comprises a container comprising a degaussing component; an abrasive material; and at least one fastener removal device.

### RELATED APPLICATIONS

This application claims the benefit of provisional patent application Ser. No. 61/278,969 filed 2009 Oct. 14 by the present inventor, the entirety of which is incorporated herein by reference.

### BACKGROUND ART

The present invention relates generally to a method of and apparatus for preventing data recovery from a disk drive apparatus for reading/writing information from/onto a disk-shaped storage medium (hereinafter referred to as a “disk”). Data is recorded on a recording surface that is comprised of a disk made of a stable substrate with an applied magnetic coating capable of storing recorded data and allowing said data to be written or retrieved via read/write heads. The disks usually are inside a protective case and rotate to allow the read/write heads to access data stored on the disk. The read/write heads can move back and forth to access data that is stored between near the center of the disk or near the outside edge of the disk.

A disk drive apparatus known to the inventor is depicted in FIG. 2. FIG. 2 depicts a head disk assembly (hereinafter referred to as an “HDA”) of a magnetic disk drive apparatus 100 with a magnetic disk 200 loaded therein. The magnetic disk 200, as a storage medium, is secured on the rotating member of a spindle motor (not shown) by a disk clamp 220, so that the magnetic disk 200 is rotated by the rotation of the spindle motor.

The magnetic disk drive apparatus 100 includes a magnetic head 230 for writing information onto the magnetic disk 200. The magnetic head 230 is pivotally secured on a pivot 250 via a head arm 240. The magnetic head 230 can be moved substantially in the radial direction of the magnetic disk 200 by moving the head arm 240 by using a voice coil motor 280 including a coil section 260 and a magnetic circuit 270. The spindle motor (not shown), the pivot 250 and the magnetic circuit 270 are secured to a base 290.

The magnetic disk drive apparatus 100 rotates the magnetic disk 200 counterclockwise by driving the spindle motor (not shown).

While the disk is rotating, the magnetic head 230 is moved as necessary between the outer periphery and the inner periphery of the magnetic disk 200 by pivoting the head arm 240 about the pivot 250.

The operations of the magnetic head 230, the spindle motor (not shown), the voice coil motor 280 for moving the magnetic head 230, etc., are controlled by an upper-level device (not shown). The upper-level device outputs signal for controlling the operations of the magnetic head 230, the spindle motor (not shown), etc., so as to read/write information from/onto the magnetic disk 200. When the magnetic disk drive apparatus 100 receives a read command from the upper-level device, a seek operation is performed to move the magnetic head 230 to an intended track, and information is read by the magnetic head 230 from the intended track.

Hard disk drives are devices that are used in electronic devices such as computers, music players, photo copy machines and other devices that have a need to store electronic data. A hard disk drive has the ability to store and retrieve data for long or short term usage. Data stored on a hard disk drive will remain on the hard disk even after the device has been turned off giving the ability to use it for data storage longer than the time during which the device has power applied and is in an operating state. Even if the device has been unplugged so it has no source of electricity the data will remain on the hard disk.

Prior to this method, users would need expensive tools or specialized knowledge to give 100% data security. Prior methods such as using special programs that claim to erase all of the data on a hard disk, reformatting the disk, reinstalling the operating system on the disk, deleting confidential data from the disk, hitting the disk with a hammer or even drilling holes through the disk cannot ensure data removal. There was still a chance that some data remained on the hard disk that could be recovered. Some other methods are very dangerous (such as burning at high temperatures with chemicals such as thermite).

Because data could be left on a hard disk, when said hard disk has been disposed of, data could be recovered and used against the original owner for purposes such as identity theft.

### BRIEF DESCRIPTION OF THE DRAWINGS

FIG. 1 is a top view of a disk drive apparatus with the disk drive apparatus top cover plate still attached.

FIG. 2 is a perspective view of a disk drive apparatus with the disk drive apparatus top cover plate removed showing the inside mechanism.

FIG. 3 is a perspective view showing a fastener removal tool being used to remove a screw used to secure the disk drive apparatus top cover plate.

FIG. 4 is a perspective view of a disk drive apparatus with the disk drive apparatus top cover plate removed showing a fastener removal tool removing a screw retaining the disk clamp.

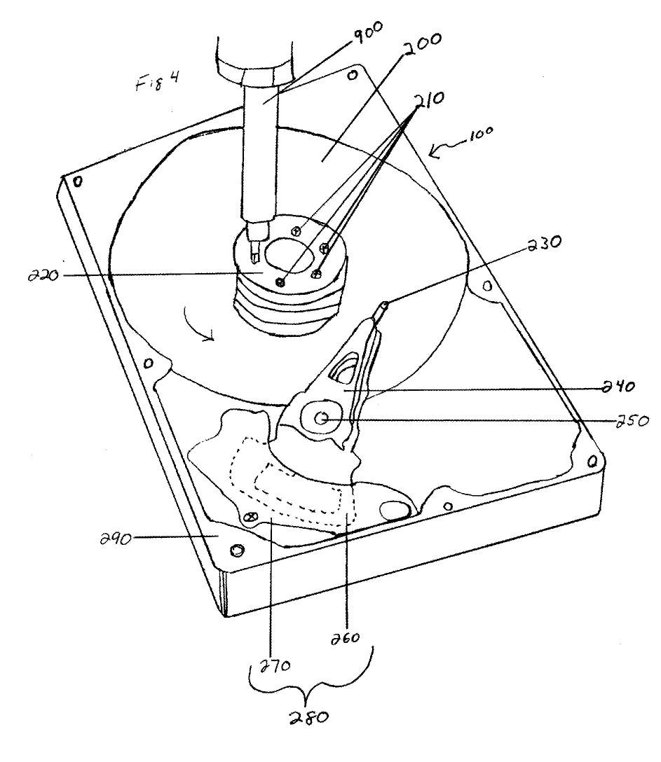

FIG. 5 is a perspective view showing a magnet being used to degauss the surface of a disk.

FIG. 6 is a perspective view of an abrasive material being used to abrade the surface of a disk surface.

FIG. 7 is a perspective view of a disk being deformed.

FIG. 8 is a perspective view of a deformed disk.

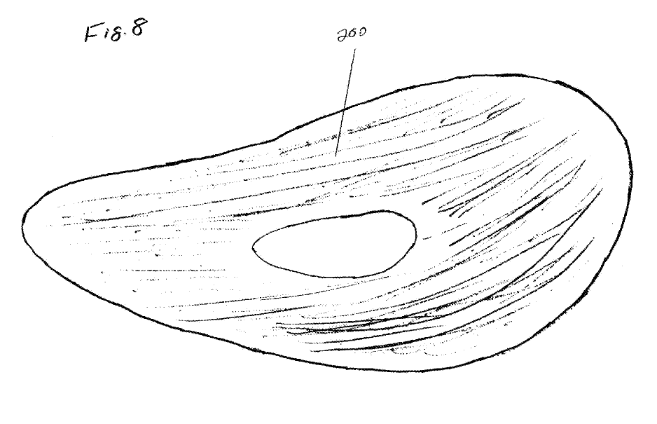

FIG. 9 is a top view of a set of tools that could be used for the Disassembly and Destruction of a Hard Disk Drive.

FIG. 10 is a functional flow diagram of an embodiment of the present invention.

### DRAWINGS—REFERENCE NUMERALS

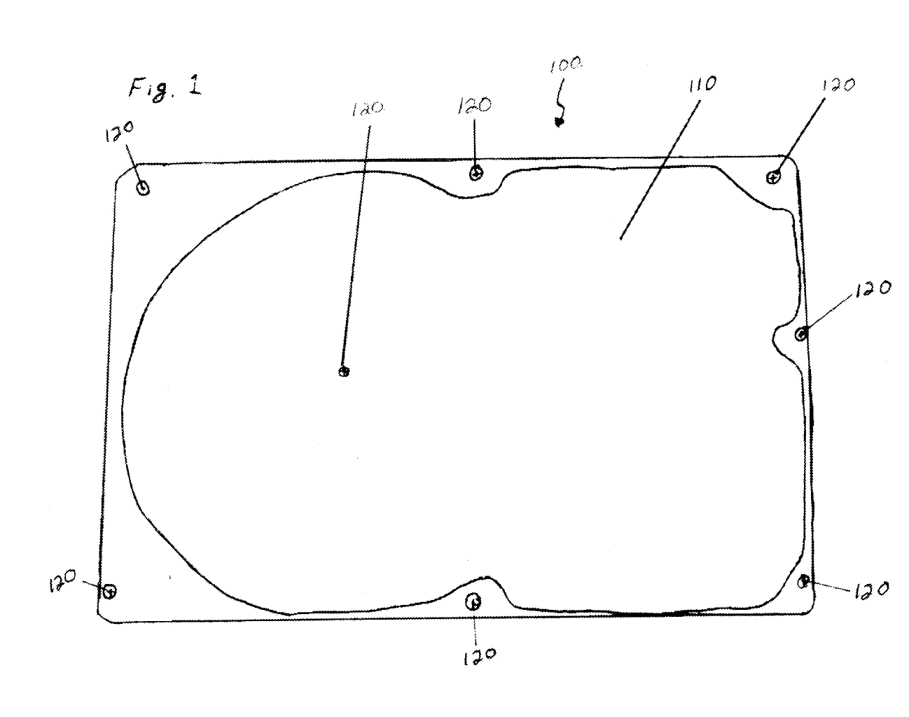

FIG. 1
100—Disk drive apparatus
110—Disk drive apparatus top cover plate
120—Screw

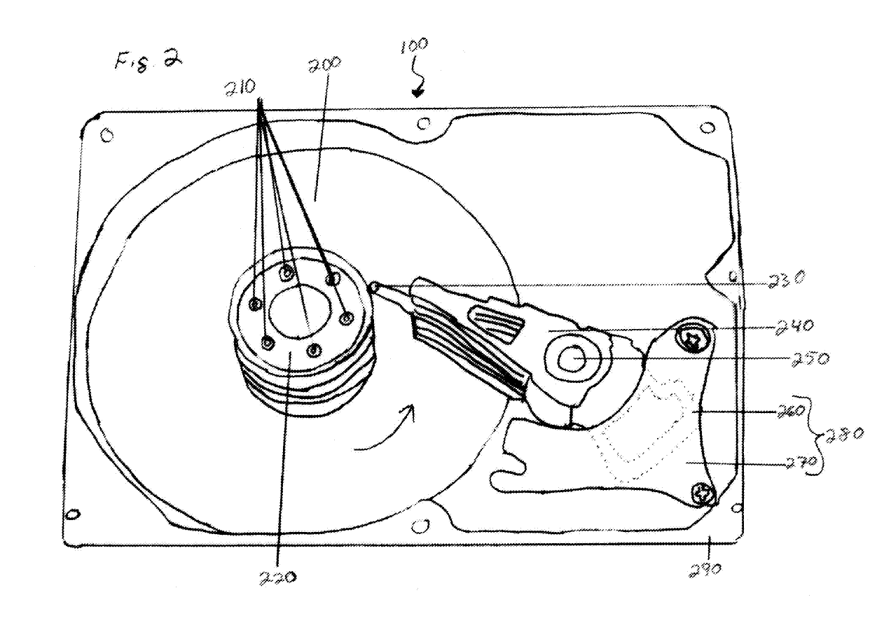

FIG. 2
200—Disk
210—Screw
220—Disk clamp
230—Magnetic head
240—Pivot
250—Head Arm
260—Coil section
270—Magnetic circuit
280—Voice coil motor
290—Base

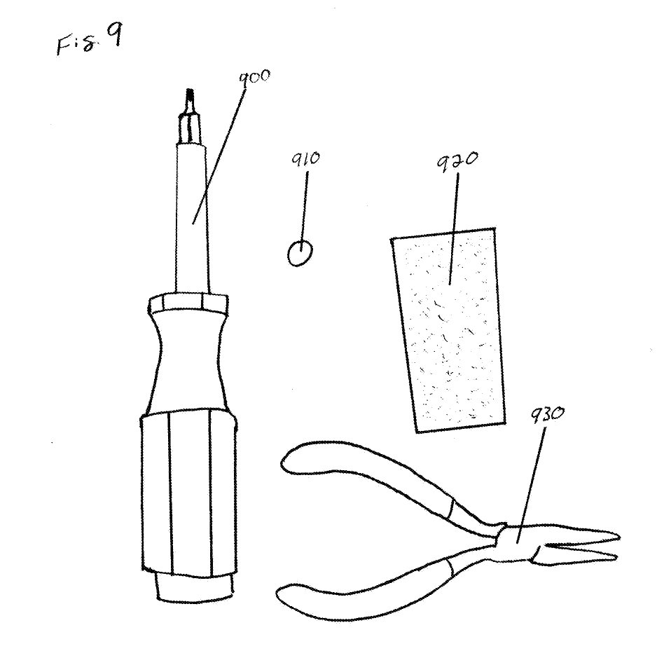

FIG. 9
900—Fastener removal tool
910—Magnetic device with sufficient strength to degauss the recorded data on the surface of the disk.
920—Abrasive material
930—Pliers

### DETAILED DESCRIPTION

A method and apparatus for the disassembly and physical destruction of the data stored in hard disks are described. In the following description, for purposes of explanation, numerous specific details are set forth in order to provide a thorough understanding of the present invention. It will be apparent; however, that the present invention may be practiced without these specific details. In other instances, well-known methods of the physical destruction of data from a hard disk are available in order to avoid unnecessarily obscuring the present invention.

The user would follow these steps once the hard disk drive has been removed from the appliance that it was once part of:
Open the lid of the hard disk drive to provide access to the data platter(s)
Remove the data platters
These next steps can be performed in any order:
   Using a device capable of having or generating a sufficient magnet field, degauss the recording surface(s) of each data platter.
   Abrade both sides of each of the data platters removing the recording medium.
   Deform (if the platter is metal) or break the disk(s) into multiple pieces (if the platter is glass) so they are no longer flat.

The starting materials for a first embodiment for the destruction of a hard disk drive 100 are illustrated in FIG. 9. The kit of components consists of, but is not limited to:
A cardboard box (not shown) the kit was packaged and/or shipped in
Magnetic device 910 with sufficient strength to degauss the recorded data on the surface of the disk
Screwdriver(s) 900 (or other fastener removal device) of the appropriate types and/or sizes needed to disassemble a hard disk drive including but not limited to: TORX sizes T5, T6, T7, T8, T9, Philips bits of sizes #00, #0, #1, #2, flat blade bits of size range 1 mm through 3 mm. In one or more embodiments, larger, smaller, and/or differing types of fastener removal devices may be used.
pliers 930
Abrasive material 920 of a type that having the ability to abrade the surface of the disk platter.

This embodiment describes how to disassemble the hard disk drive 100 and remove the disk platter(s) 200 from the body of the hard disk drive 200.

Place the disk drive apparatus 100 with disk drive apparatus top cover plate 110 facing up on top of a flattened cardboard box.

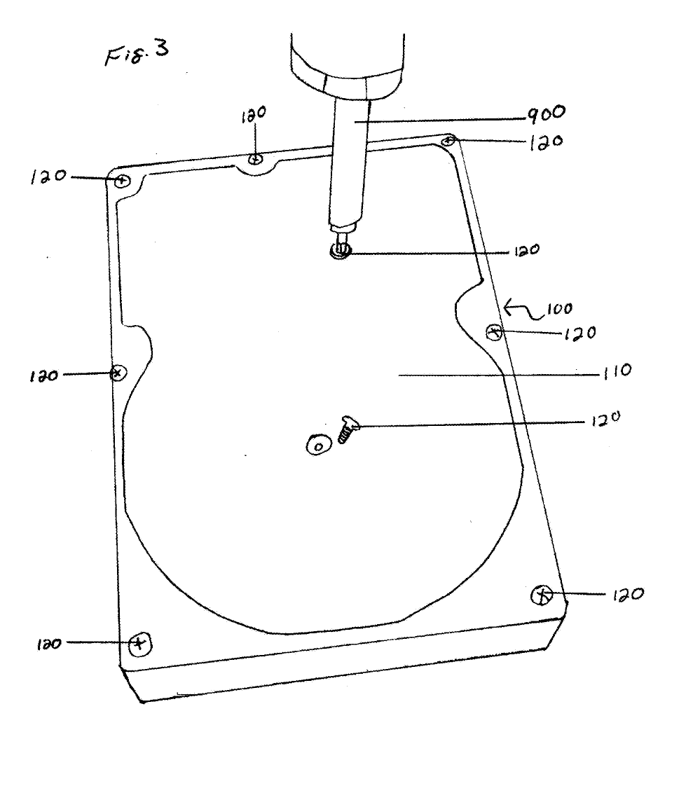

Using a Fastener removal tool 900 (screwdriver) with the appropriate bit remove the screws 120 securing the disk drive apparatus top cover plate 110 (FIG. 3).

Remove the disk drive apparatus top cover plate 110.

Using a Fastener removal tool 900 with the appropriate bit remove the disk clamp screw(s) 210 that hold the disk clamp(s) 220 that secure the disk(s) 200 in place. Remove the disk(s) 200.

The remaining steps can be performed in any order and still achieve the same results.

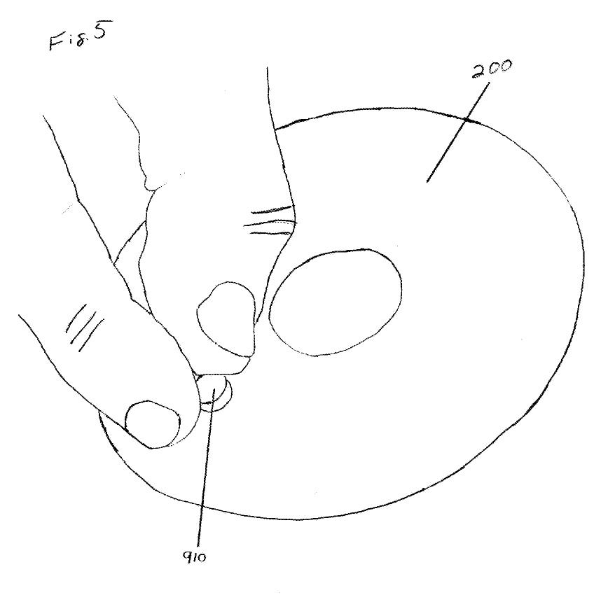

Rub magnetic device with sufficient strength to degauss the recorded data on the surface of the disk 910 over the surfaces (both sides) of each disk 200 making sure to cover the entire surface (FIG. 5). This step will erase the data on the disk 200 surfaces.

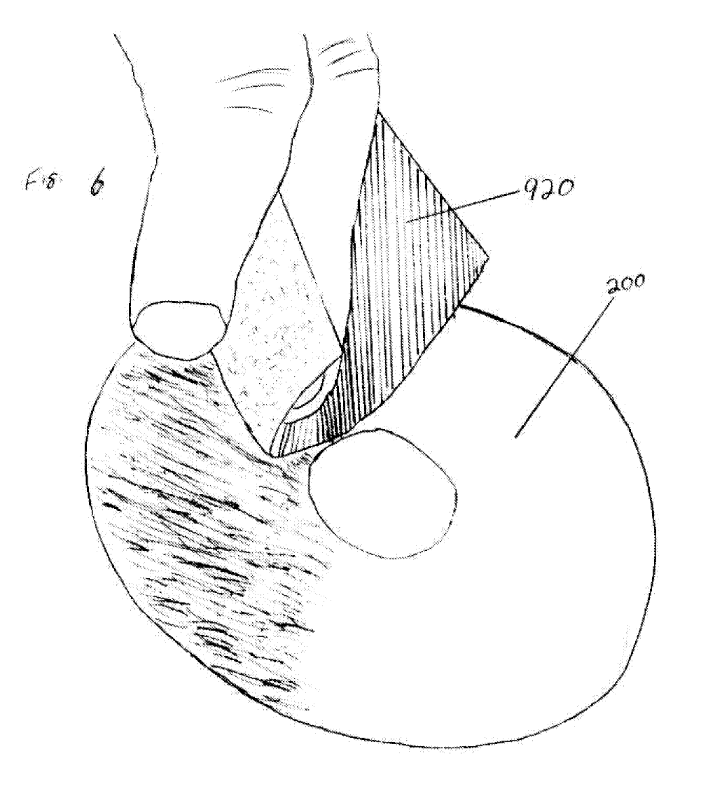

Using the abrasive material 920 thoroughly abrade the entire surface of each disk platter 200 on both sides (FIG. 6).

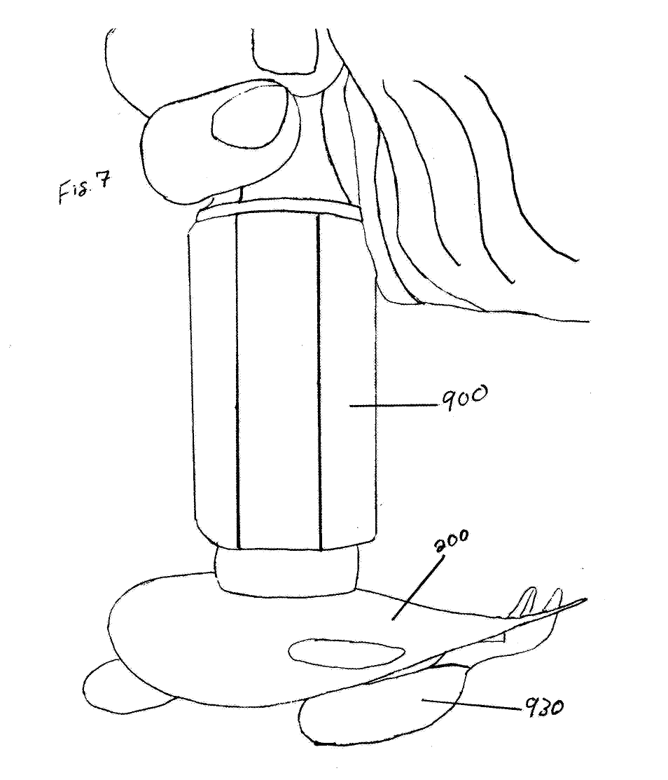

Deform each of the disk(s) removed so they are no longer flat. There are many ways to safely perform this step. One possible way to do this is to place one of the disk(s) 200 on the handle of the pliers 930 (FIG. 7). Grasp the fastener removal tool 900 firmly and then strike the disk 200 with the handle end of the fastener removal tool 900 hitting the disk 200 in the space between the pliers 930 handles to deform the disk 200 (FIG. 7).

In at least some embodiments, the steps of degaussing the recording surface, abrading both sides of the data platter, and deforming or breaking the disk are performed in differing orders without departing from the scope and spirit of the disclosed embodiments. In at least one embodiment, a minimum of two of the steps of degaussing the recording surface, abrading both sides of the data platter, and deforming or breaking the disk are performed. In at least one embodiment all of the steps of degaussing the recording surface, abrading both sides of the data platter, and deforming or breaking the disk are performed.

The tools necessary for the disassembly of a hard disk drive that can be supplied to the user include, but are not limited to: Fastener removal tool(s) with the appropriate tips needed to remove the screws that hold a hard disk apparatus drive together, a magnetic device with sufficient strength to degauss the recorded data on the surface of the disk, an abrasive material and pliers.

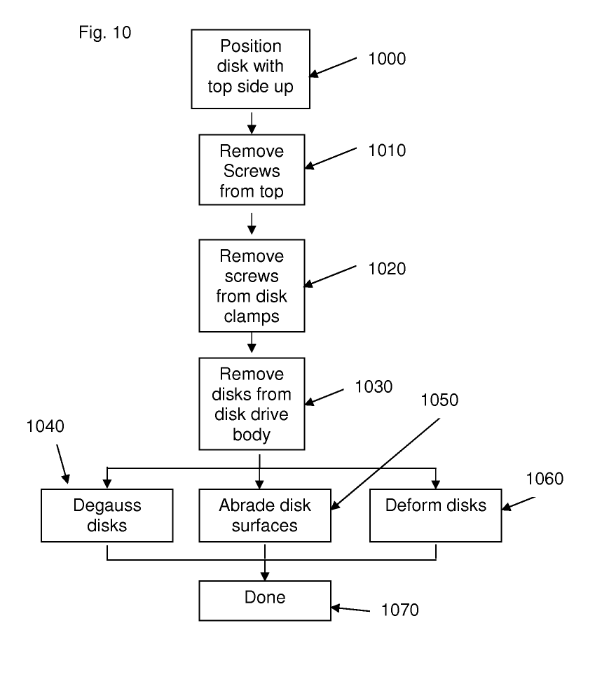

FIG. 10 is a process flow diagram of a method of preventing data recovery according to an embodiment. In at least one embodiment, the process flow from one or more of steps 1040, 1050, or 1060 may loop back to another one of steps 1040, 1050, or 1060 to perform a second pass of a remaining (unperformed) step. In at least one embodiment, each of the steps 1040, 1050, and 1060 are performed at least one time.

Hardware Overview

Embodiments of the invention are not limited to any specific combination of hardware circuitry and software.

An advantage of this method is that the user of either high or low skill level can safely, easily and quickly prevent someone of either low or high skill level from recovering data that had been stored on the hard disk drive. The present invention can safely be performed inside someone's home without risk of damage or danger. There are no chemicals used in this process so there are no noxious or dangerous fumes produced. No special facilities are required to perform the method described herein nor are any special tools needed beyond those that can be provided to the user.

More particularly, one or more embodiments according to the present invention relate to a method that enables users, who would not otherwise have the ability, the ability to prevent data recovery from their disk by the disassembly of said disk and removing the magnetically recorded data from said disk.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of destroying data on a data platter comprising:
performing at least one of degaussing at least a portion of the data platter, removing at least a portion of a recording surface of the data platter, or deforming at least a portion of the data platter, and;
performing at least a different one of degaussing at least a portion of the data platter, removing at least a portion of a recording surface of the data platter, or deforming at least a portion of the data platter.

2. The method of claim 1 wherein degaussing comprises:
erasing data stored on the data platter by a magnetic device capable of generating a sufficient magnetic field.

3. The method of claim 2 further comprising using the magnetic device to erase both sides of the data platter.

4. The method of claim 1 wherein removing comprises:
removing the recording surface of the data platter with an abrasive.

5. The method of claim 1 wherein deforming comprises deforming the data platter so as to no longer be flat.

6. The method of claim 1 further comprising performing the remaining one of degaussing at least a portion of the data platter, removing at least a portion of a recording surface of the data platter, or deforming at least a portion of the data platter.

7. The method of claim 1 further comprising removing the data platter from a hard disk drive enclosure.

8. A kit for destroying data on a data platter comprising:
a container comprising:
a degaussing component;
an abrasive material; and
at least one fastener removal device.

9. The kit as claimed in claim 8, wherein the fastener removal device is at least one of a screwdriver or a screwdriver bit.

10. The kit as claimed in claim 8, wherein the fastener removal device is at least one of a Phillips head screwdriver, a blade screwdriver, a Torx screwdriver, a square drive screwdriver, or a star-shaped screwdriver.

11. The kit as claimed in claim 8 further comprising a set of instructions for informing a user to perform at least one of degaussing at least a portion of the data platter, removing at least a portion of a recording surface of the data platter, or deforming at least a portion of the data platter and perform at least a different one of degaussing at least a portion of the data platter, removing at least a portion of a recording surface of the data platter, or deforming at least a portion of the data platter.
